(19) United States
(12) Patent Application Publication
(10) Pub. No.: US 2013/0162924 A1
(43) Pub. Date: Jun. 27, 2013

(54) SWITCHABLE PRIVACY FILTER

(71) Applicants: Hassan Sahouani, Hastings, MN (US); Marie A. Boulos, West Saint Paul, MN (US); John J. Stradinger, Roseville, MN (US)

(72) Inventors: Hassan Sahouani, Hastings, MN (US); Marie A. Boulos, West Saint Paul, MN (US); John J. Stradinger, Roseville, MN (US)

(73) Assignee: 3M INNOVATIVE PROPERTIES COMPANY, ST. PAUL, MN (US)

(21) Appl. No.: 13/819,401

(22) PCT Filed: Aug. 8, 2011
(86) PCT No.: PCT/US11/46883

§ 371 Date: Feb. 27, 2013

Related U.S. Application Data
(60) Provisional application No. 61/381,242, filed on Sep. 9, 2010.

(51) Int. Cl. G02F 1/133; G02F 1/1337

(52) U.S. Cl. CPC G02F 1/13306; G02F 1/1337
USPC 349/41; 349/123; 349/96

(57) ABSTRACT

The disclosure generally relates to optical elements such as switchable privacy filters useful for displaying information in at least two modes. In the first mode, the viewing angle can be limited to restrict viewing to near-normal orientations. In the second mode, the viewing angle can be increased so that the information can be viewed at larger oblique angles. The disclosure also relates to switchable privacy displays that include the switchable privacy filters.

### BACKGROUND

A privacy filter such as a light control film (LCF) or a light collimating film is an optical film that is configured to regulate the transmission of light. Various LCFs are known, and typically include a light transmissive film having a plurality of parallel grooves wherein the grooves are formed of a light-absorbing material.

LCFs can be placed proximate a display surface, image surface, or other surface to be viewed. At normal incidence, (that is 0 degree viewing angle) where a viewer is looking at an image through the LCF in a direction that is perpendicular to the film surface, the image is viewable. As the viewing angle increases, the amount of light transmitted through the LCF decreases until a viewing cutoff angle is reached where substantially all the light is blocked by the light-absorbing material and the image is no longer viewable. This can provide privacy to a viewer by blocking observation by others that are outside a typical range of viewing angles.

LCFs can be prepared by molding and ultraviolet radiation curing a polymerizable resin on a polycarbonate substrate. Such LCFs are commercially available from 3M Company, St. Paul, Minn., under the trade designation “3M™ Filters for Notebook Computers and LCD Monitors”.

### SUMMARY

The disclosure generally relates to optical elements such as switchable privacy filters useful for displaying information in at least two modes. In the first mode, the viewing angle can be limited to restrict viewing to near-normal orientations. In the second mode, the viewing angle can be increased so that the information can be viewed at larger oblique angles. The disclosure also relates to switchable privacy displays that include the switchable privacy filters.

In one aspect, the present disclosure provides an optical element useful in a switchable privacy filter includes a first polymeric substrate having an outer surface, a first electrically conductive layer opposite the outer surface, and a first oriented chromonics alignment layer disposed on the first electrically conductive layer. The optical element further includes a second polymeric substrate having a second electrically conductive layer facing the first electrically conductive layer and a second oriented chromonics alignment layer disposed on the second electrically conductive layer. The optical element still further includes a guest-host liquid crystal material (LCM) that includes a first absorbing dye, the LCM disposed between the first and the second polymeric substrates and immediately adjacent the first and the second oriented chromonics alignment layers. Each of the first and the second oriented chromonics alignment layers include a chromonics molecular orientation direction parallel to each other.

In another aspect, the present disclosure provides a switchable privacy filter includes an optical element useful in a switchable privacy filter and a switchable electrical source. The optical element useful in a switchable privacy filter includes a first polymeric substrate having an outer surface, a first electrically conductive layer opposite the outer surface, and a first oriented chromonics alignment layer disposed on the first electrically conductive layer. The optical element further includes a second polymeric substrate having a second electrically conductive layer facing the first electrically conductive layer and a second oriented chromonics alignment layer disposed on the second electrically conductive layer. The optical element still further includes a guest-host liquid crystal material (LCM) that includes a first absorbing dye, the LCM disposed between the first and the second polymeric substrates and immediately adjacent the first and the second oriented chromonics alignment layers. Each of the first and the second oriented chromonics alignment layers include a chromonics molecular orientation direction parallel to each other. The switchable electrical source is further in contact with the first and second electrically conductive layers, and is capable of switching the LCM transmission axis between parallel and perpendicular orientations to the chromonics molecular orientation direction.

In yet another aspect, the present disclosure provides a switchable privacy display that includes a switchable privacy filter and an information bearing display disposed adjacent the switchable privacy filter. The switchable privacy filter includes an optical element useful in a switchable privacy filter and a switchable electrical source. The optical element useful in a switchable privacy filter includes a first polymeric substrate having an outer surface, a first electrically conductive layer opposite the outer surface, and a first oriented chromonics alignment layer disposed on the first electrically conductive layer. The optical element further includes a second polymeric substrate having a second electrically conductive layer facing the first electrically conductive layer and a second oriented chromonics alignment layer disposed on the second electrically conductive layer. The optical element still further includes a guest-host liquid crystal material (LCM) that includes a first absorbing dye, the LCM disposed between the first and the second polymeric substrates and immediately adjacent the first and the second oriented chromonics alignment layers. Each of the first and the second oriented chromonics alignment layers include a chromonics molecular orientation direction parallel to each other. The switchable electrical source is further in contact with the first and second electrically conductive layers, and is capable of switching the LCM transmission axis between parallel and perpendicular orientations to the chromonics molecular orientation direction.

In yet another aspect, the present disclosure provides a switchable privacy display that includes an information bearing display having an outer surface, a first electrically conductive layer adjacent the outer surface, and a first oriented chromonics alignment layer disposed on the first electrically conductive layer. The switchable privacy display further includes a polymeric substrate having a second electrically conductive layer facing the first electrically conductive layer and a second oriented chromonics alignment layer disposed on the second electrically conductive layer. The switchable privacy display still further includes a guest-host liquid crystal material (LCM) comprising a first absorbing dye, the LCM disposed between the outer surface and the polymeric substrate, and immediately adjacent the first and the second oriented chromonics alignment layers, wherein each of the first and the second oriented chromonics alignment layers include a chromonics molecular orientation direction parallel to each other.

The above summary is not intended to describe each disclosed embodiment or every implementation of the present disclosure. The figures and the detailed description below more particularly exemplify illustrative embodiments.

### BRIEF DESCRIPTION OF THE DRAWINGS

Throughout the specification reference is made to the appended drawings, where like reference numerals designate like elements, and wherein:

FIG. 1A shows a schematic cross-section of a switchable privacy display;

FIG. 1B shows a schematic cross-section of a switchable privacy display;

FIG. 2 shows a schematic cross-section of a switchable privacy filter;

FIG. 3 shows a schematic cross-section of a switchable privacy filter;

FIG. 4A shows a schematic of a switchable privacy filter in the private mode; and

FIG. 4B shows a schematic of a switchable privacy filter in the public mode.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

Advances in display technology have resulted in brighter, higher resolution and more energy efficient displays that consumers want. The brightness and resolution of a display can be reduced when a privacy filter such as an LCF is positioned in front of the display for security or other purposes. It would be desirable to have an LCF which does not reduce the brightness and resolution of a display. It would also be desirable to have a privacy filter that can be switched between two different viewing modes, such as a private mode where only a viewer directly in front of the display can observe the information, and a public mode where the information can be shared with viewers that view from larger angles.

Traditional computer privacy filters typically rely on a structured film to deprive the side viewer from seeing the computer display at angles other than normal to the surface of the display. There are however times when people sitting next to each other desire to share the viewing field of the computer. When the computer is equipped with one of the traditional privacy filters this task may only be possible if the screen is removed from the display. An active privacy filter that can be turned on or off depending on the desired privacy can solve this problem. Such an active privacy filter, which can take the form of a liquid-crystal shutter, would preferably be constructed of thin, lightweight materials such as a polymeric film.

A common liquid crystal display, or “LCD,” contains an array of two-dimensional picture elements, or pixels. Although each pixel may, and customarily does, contain numerous optical elements, each comprises a liquid crystal cell. A liquid crystal cell generally comprises a liquid crystal material maintained between a pair of transparent substrates, and those substrates most commonly are made of glass or a polymeric material such as polyimide. Interposed between the liquid crystal material and the substrates are electrodes electrically connected to an outside signal device that, when electrically active, alter the state of the liquid crystal material. Such liquid crystal cells find application not only in displays, but also in other optical devices, including optical communication devices and other optical processing equipment.

In a liquid crystal cell, the molecules of liquid crystal material are aligned, or oriented, in a preferred direction along each of the substrates within the cell. Normally, this alignment is accomplished through the use of an alignment structure layer. Alignment layers generally are glass substrates or polymeric films, typically polyimides that are mechanically rubbed in a single direction to impart an orientating effect on the liquid crystals with which they contact. The optical activity of the liquid crystal cell is in part a function of the relative orientation of the liquid crystals at the surface of each of the substrates and the ordered change in direction of the crystals between the substrates.

Such conventional alignment layers can suffer myriad drawbacks. For example, the high temperatures necessary to process of many useful polymeric substrates prevent the incorporation of temperature-sensitive additives such as color dyes into the alignment structures. Also, the conventional rubbing, washing and drying steps used in manufacture of the layer films and substrates can be slow, expensive and introduce gross defects and low yields.

In one particular embodiment, the present switchable privacy filter can be a guest-host liquid crystal (LC), wherein the LC is mixed with an absorbing dye, sandwiched between a non polarizing chromonics alignment layer and a polarizing chromonics layer in a parallel “pi” cell type of configuration. In the active (that is, private) mode where side viewing is eliminated, a voltage is applied to the two conductive layers surrounding the guest-host LC causing the liquid crystal and the dye to adopt a homeotropic alignment configuration (LC perpendicular to the surface of the substrate). In this state the absorbing direction of the dyes in the guest-host LC is parallel to the transmission axis of the top chromonics absorbing layer thus preventing the image from being viewed at lateral angles. This configuration does not affect the view-ability of the display at normal (that is, perpendicular to the display) angles. In its passive (that is, public) state where no voltage is applied, the LC/dye will adopt a planar orientation in which the transmission axis of the dye in the guest-host LC is parallel to the transmission axis of the top chromonics polarizing layer thus allowing the side viewing of the display.

In another particular embodiment, the top chromonics layer contains no absorbing dyes but serves as an alignment layer only. In this case, the top substrate can be either replaced by a standard absorbing or reflecting polarizer, or a standard absorbing or reflecting polarizer can be positioned adjacent the top substrate.

In another particular embodiment, the switchable privacy filter can be constructed directly on top of the existing glass surface of a display, such as an LCD display. In this case, one of the substrates can be eliminated, and an electrode and oriented chromonics alignment layer can be deposited directly on the existing glass surface.

Chromonics alignment and polarizing layers of the type described herein can be found, for example, in U.S. Pat. Nos. 6,524,665 (Sahouani et al.), entitled LIQUID CRYSTAL ALIGNMENT STRUCTURES AND OPTICAL DEVICES CONTAINING SAME and U.S. Pat. No. 6,245,399 (Sahouani et al.) entitled GUEST-HOST POLARIZERS.

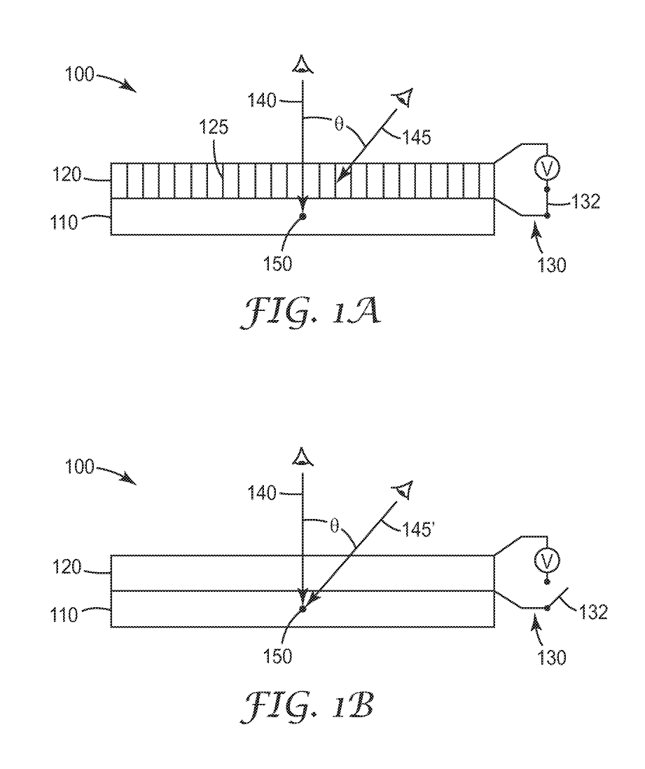

FIG. 1A shows a schematic cross-section of a switchable privacy display 100 according to one aspect of the disclosure. In FIG. 1A, an information bearing display 110 is disposed adjacent an optical element 120 such as a switchable privacy filter 120. The switchable privacy filter 120 is attached to a voltage source 130 that can be used to switch the switchable privacy filter 120 between an active (that is, private viewing) mode and a passive (that is, public viewing) mode. Switch 132 completes the circuit for activating the private viewing mode, and alignment of absorbing components 125 within the switchable privacy filter 120 permits a direct view 140 of information 150 in information bearing display 110, but prevents viewing by an indirect view 145 rotated at an oblique observation angle θ from the direct view 140. Generally, the indirect view 145 is blocked by absorption of light by absorbing components 125.

FIG. 1B shows a schematic cross-section of a switchable privacy display 100 according to one aspect of the disclosure. Each of the elements 100-150 shown in FIG. 1B correspond to like-numbered elements 100-150 shown in FIG. 1A, which have been described previously. In FIG. 1B, switch 132 is open, and does not complete the circuit for activating the private viewing mode, and switchable privacy display 100 is in the passive (that is, public viewing) mode. Both a direct view 140 and an indirect view 145′ of information 150 in information bearing display 110, is possible.

FIG. 2 shows a schematic cross-section of a switchable privacy filter 200 according to one aspect of the disclosure. The switchable privacy filter 200 includes a first substrate 210 having an outer surface 205 and a first electrically conductive layer 240 opposite the outer surface. An optional barrier layer 230 can be disposed between the first substrate 210 and the first electrically conductive layer 240, to reduce the transport of water vapor, oxygen, and the like through the first substrate 210. A first oriented chromonics alignment layer 250 is disposed on the first electrically conductive layer 240.

The switchable privacy filter 200 further includes a second substrate 220 having a second electrically conductive layer 240′ facing the first electrically conductive layer 240. An optional barrier layer 230′ can be disposed between the second substrate 220 and the second electrically conductive layer 240′, to reduce the transport of water vapor, oxygen, and the like through the second substrate 220. A second oriented chromonics alignment layer 255 is disposed on the first electrically conductive layer 240. A guest-host liquid crystal material (LCM) 260 that includes a first absorbing dye is disposed between the first substrate 210 and the second substrate 220 and immediately adjacent the first oriented chromonics alignment layer 250 and the second oriented chromonics alignment layer 255. The switchable privacy filter 200 still further includes a plurality of spacer elements 270 that provide for a uniform thickness of the guest-host LCM 260, and also edge-sealing members 280 that prevent the guest-host LCM 260 from flowing out of the switchable privacy filter 200.

In one particular embodiment, each of the first and second substrates 210, 220, can be any suitable substrate such as polymeric or glass, as described elsewhere, however polymeric substrates are particularly useful. Generally, when a polymeric substrate is used, a barrier layer can be beneficial for improving the lifetime of the switchable privacy filter 200. Optional barrier layers 230, 230′ for reducing moisture and oxygen transmission through a polymeric film are well known, and can include combinations of sub-layers such as transparent inorganic oxides and transparent polymeric sub-layers. Representative barrier layers useful in the present disclosure include those described in, for example, U.S. Pat. No. 5,440,446 (Shaw et al.); U.S. Pat. No. 5,725,909 (Shaw et al.); U.S. Pat. No. 7,018,713 (Padiyath et al.); and also in U.S. Patent Publication No. 2009/0252894 (McCormick et al.).

In one particular embodiment, each of the first electrically conductive layer 240 and the second electrically conductive layer 240′ can comprise any suitable electrically conductive material known to one of skill in the art, including, for example, transparent conductive oxides such as indium tin oxide, transparent hybrid conductors such as metal enhanced oxide conductors, organic conductors such as PEDOT (poly(3,4-ethylenedioxythiophene)) and similar materials, silver nanowires, carbon nanotubes, graphene, or combinations thereof, and the like.

In one particular embodiment, at least one of the first and second oriented chromonics alignment layers 250, 255 includes a second absorbing dye aligned parallel to the chromonics molecular orientation direction (that is, the “x” direction). For example, the second oriented chromonics alignment layer 255 including the second absorbing dye aligned as described, permits switching of the switchable privacy filter 200 to private viewing mode, as described elsewhere.

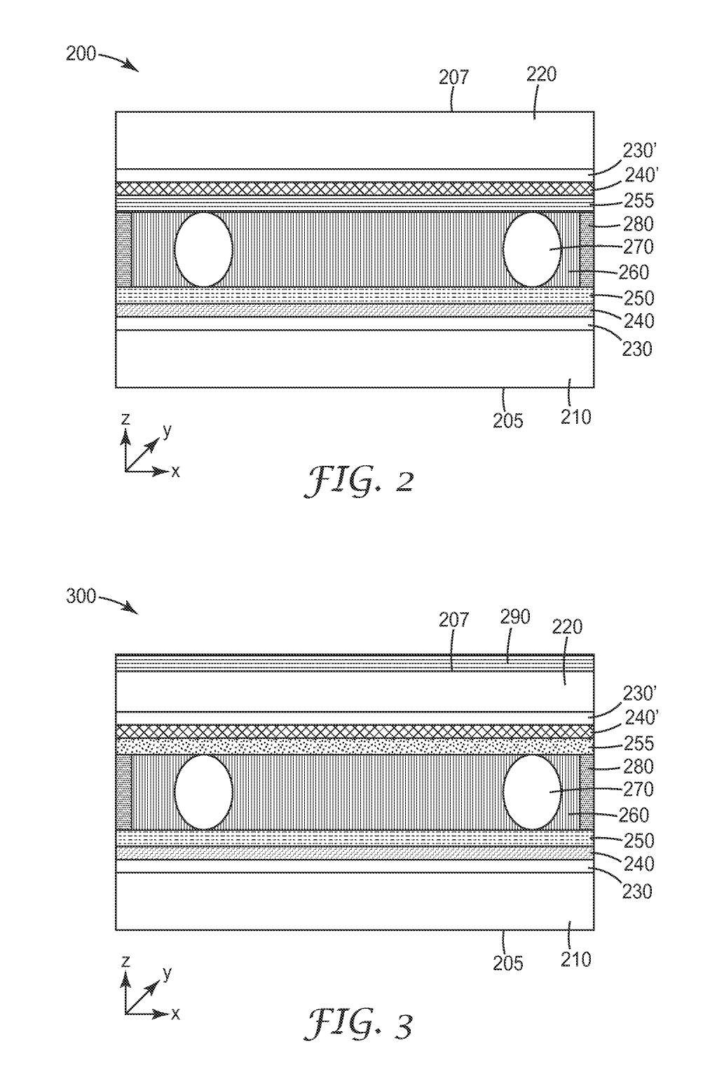

FIG. 3 shows a schematic cross-section of a switchable privacy filter 300 according to one aspect of the disclosure. Each of the elements 205-280 shown in FIG. 3 correspond to like-numbered elements 205-280 shown in FIG. 2, which have been described previously. In FIG. 3, both the first oriented chromonics alignment layer 250 and the second oriented chromonics alignment layer 255 do not contain any absorbing dye. In this particular embodiment, an absorbing (or reflective) polarizer 290 is disposed adjacent a second outer surface 207, such that the transmission axis of the absorbing polarizer 290 is aligned perpendicular (that is, in the “y” direction) to the chromonics molecular orientation direction (the “x” direction). In this embodiment, the alignment of the polarizer 290 relative to the chromonics molecular orientation permits switching of the switchable privacy filter 200 to private viewing mode, as described elsewhere.

In one particular embodiment, the liquid crystal alignment (or, synonymously orientation) structures comprise a substrate onto which there is coated a layer of chromonic liquid crystal material having an ordered molecular structure. The chromonic liquid crystal materials may be easily ordered, for example, by the application of shear force to the materials, such as occurs during coating of the materials out of aqueous solution. For sufficient applied shear, the liquid crystalline material can assume an ordered orientation that, upon drying, provides an orientation or alignment substrate useful to orient bulk liquid crystal material in a liquid crystal cell or useful to align or order a non-liquid crystal coating. Because the levels of shear stress created during orientation of the chromonic liquid crystal material are low compared to the shear stresses that might cause mechanical deformation of the substrates onto which the material is applied, the process of forming the alignment structures has a reduced tendency to create stresses that might distort the optical properties of the substrate. For certain applications, the alignment or orientation configurations allow for the use of more flexible substrates without regard to the degrading of optical properties.

Any lyotropic liquid crystal material that forms an ordered structure when applied to a suitable substrate can be employed. Useful lyotropic materials thus include those that form a variety of ordered structures upon application, including crystalline structures, lyotropic films, and other molecular orderings. Typically, the most useful lyotropic liquid crystal materials will be those nematic liquid crystal materials that contain at least one triazine group, including those of the type disclosed in U.S. Pat. No. 5,948,487 (Sahouani et al.) entitled, ANISOTROPIC RETARDATION LAYERS FOR DISPLAY DEVICES. Preferably, the lyotropic liquid crystal materials are colorless. One class of particularly useful lyotropic materials are those known as “chromonics.” See, for example, Attwood, T. K., and Lydon, J. E., 1984, I Molec. Crystals liq. Crystals, 108, 349. Chromonics are large, multi-ring molecules typically characterized by the presence of a hydrophobic core surrounded by various hydrophilic groups. The hydrophobic core can contain aromatic and/or non-aromatic rings. When in solution (typically above about 5 percent by weight of solution), these chromonic molecules tend to aggregate into a nematic ordering characterized by a long range order.

In some cases, the performance of the chromonics liquid crystal materials can be enhanced with the incorporation of one or more additive compounds. One useful additive is dimethylamino pyridine (“DMAP”), which when added to the chromonic liquid crystal material in amounts between about 1 and 5 percent by weight (more preferably between about 1 and 2 weight percent) improves the optical clarity of the liquid crystal material. Other useful additives include dyes and simple sugars, for example, sucrose, glucose and fructose, which can be added in similar concentrations. Depending on the techniques employed to make devices incorporating the alignment structures, relatively temperature-stable additive materials (for example, DMAP) may be preferred.

Layers of these and other chromonic molecules dried from shear coated solutions show a self-organized surface structure that easily and uniformly orient liquid crystals or non-liquid crystal coatings in a planar configuration. Coating of the chromonic liquid crystalline materials can be preformed by any convenient means that provides for the ordered arrangement of the liquid crystals along the plane of the substrate onto which they are applied. Typically, coating techniques that impart shear stress to the coating material during the coating process will be preferred since shear stress imparted during coating can serve to form large and uniform domains of the ordered chromonic liquid crystal molecules. Coating techniques that impart such shear stresses include wire-wound rod coating and conventional extrusion dye coating.

Drying of the coated chromonic layer can be performed using any means suitable for drying aqueous coatings. Useful drying techniques will not damage the coating or significantly disrupt any molecular ordering of the coated layer imparted by shear stress or other ordering effects applied during coating or application.

Substrates onto which the chromonic materials can be applied include any solid material that will accept the coating of the liquid crystal material and that possesses whatever optical characteristics may be desired for its intended application. For example, transparency, translucency or reflectivity may be indicated for a given application. Suitable substrate materials include, for example, glass, rigid polymeric materials, flexible polymeric films, multilayer films and optical stacks. In addition to the layer of liquid crystal material, the substrates can also include any other layers customarily found in display devices or other components useful in displays. Such additional layers include, for example, polarizers, retarders, color filters, black matrices and electronically-addressable active or passive devices (for example, transparent electrodes, organic and inorganic light emitting devices and thin film transistors) and the like. Thus, useful substrates can include one or more optically active layers (such as polarizers, color filters, etc.) and/or one or more additional layers or materials that can be used to affect or control the transmission, reflection, or absorption of light through an overall display construction. Suitable substrate materials can be colored or clear and can be birefringent or non-birefringent, although transparent low-birefringent materials are preferred.

Coating solutions of the chromonic materials can be made by preparing a simple aqueous solution of water and a pH-adjusting compound such as NH4OH. The coating solution can then be prepared by dissolving the chromonic material in aqueous solution along with other additives such as surfactants and one or more polarizing and/or filtering dyes. Suitable water-soluble polymeric binders can also be added in small amounts to the solutions in amounts ranging from less than about 1 percent by weight to 5 percent or more. Polymers found useful for this purpose include dextran-type polymers and their sulfates and sulfonated polystyrenes. Generally, the liquid crystal materials can be added in amounts sufficient to form a solution of the chromonic material with a concentration in the range from about 8 to about 20 percent by weight of solution, though concentrations in the range from about 10 to about 16 percent are more often preferred. Solutions of the chromonic material outside this concentration range can also be used provided a desired level of functionality is preserved. For example, a solution of the chromonic material should provide sufficient levels of ordered material on the final substrate and should therefore be sufficiently concentrated to provide adequate coating thickness and dryability, but not so concentrated as to be prohibitively difficult to coat and/or orient.

In some cases, it may be particularly desirable to incorporate one or more color dyes directly into the alignment structure to provide polarizing and/or color filtration functions. Such incorporation can eliminate the need for additional, separate polarizers or color filter layers in an overall display construction. For example, one or more pleochroic dyes can be incorporated into the ordered matrix of the chromonic material to provide an ordered color polarizer. The incorporated dyes can be selected to provide a variety of useful filtration and polarizing optical effects in a display construction. Many such constructions are described, for example, in U.S. Pat. No. 6,730,446 (Sahouani et al.) entitled DUAL COLOR GUEST-HOST POLARIZERS AND DEVICES CONTAINING GUEST-HOST POLARIZERS.

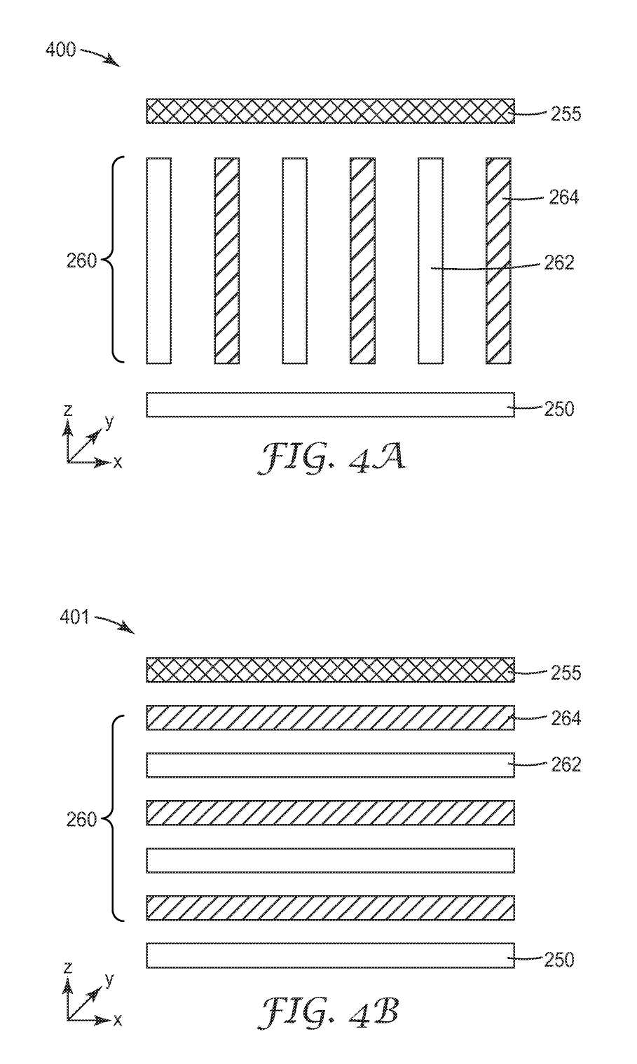

FIG. 4A shows a schematic of a switchable privacy filter 400 in the private mode, and FIG. 4B shows a schematic of a switchable privacy filter 401 in the public mode, according to one aspect of the disclosure. Each of the elements 250-260 shown in FIG. 4A-4B correspond to like-numbered elements 250-260 shown in FIG. 2, which have been described previously. In FIG. 4A-4B, the second oriented chromonics alignment layer 255 includes the second absorbing dye as described elsewhere. The guest-host LCM 260 is shown as comprising two different components: a liquid crystal (LC) material 262 and a first absorbing dye 264 that is dispersed in and aligned with the LC material 262. In the active mode shown in FIG. 4A, the transmission axis of the first absorbing dye is perpendicular to that of the second oriented chromonics alignment layer 255 including the second absorbing dye, and any public view direction is blocked. In the passive mode shown in FIG. 4B, the transmission axis of the first absorbing dye is parallel to that of the second oriented chromonics alignment layer 255 including the second absorbing dye, and any public view direction is unblocked. It is to be understood that the second absorbing dye could be removed from second oriented chromonics alignment layer 255, and a polarizer 290 added to FIGS. 4A-4B (resulting in the configuration shown in FIG. 3), and a similar switching from active to passive will result.

Following are a list of embodiments of the present disclosure.

Item 1 is an optical element, comprising: a first polymeric substrate having an outer surface, a first electrically conductive layer opposite the outer surface, and a first oriented chromonics alignment layer disposed on the first electrically conductive layer; a second polymeric substrate having a second electrically conductive layer facing the first electrically conductive layer and a second oriented chromonics alignment layer disposed on the second electrically conductive layer; and a guest-host liquid crystal material (LCM) comprising a first absorbing dye, the LCM disposed between the first and the second polymeric substrates and immediately adjacent the first and the second oriented chromonics alignment layers, wherein each of the first and the second oriented chromonics alignment layers include a chromonics molecular orientation direction parallel to each other.

Item 2 is the optical element of item 1, further comprising an absorbing polarizer adjacent the outer surface and having a transmission axis aligned perpendicular to the chromonics molecular orientation direction.

Item 3 is the optical element of item 1 or item 2, wherein at least one of the first and the second oriented chrominics alignment layers further comprises a second absorbing dye aligned parallel to the chromonics molecular orientation direction.

Item 4 is the optical element of item 3, wherein the second absorbing dye comprises a dichroic dye aligned to the chromonics molecular orientation direction.

Item 5 is the optical element of item 1 to item 4, further comprising a barrier layer disposed between each of the first and second polymeric substrates and their respective first and second electrically conductive layers.

Item 6 is the optical element of item 1 to item 5, wherein each barrier layer comprises a plurality of sub-layers.

Item 7 is the optical element of item 6, wherein at least one of the sub-layers comprises a polymeric material or an inorganic material.

Item 8 is the optical element of item 7, wherein the inorganic material comprises silica. Item 9 is the optical element of item 1 to item 8, wherein at least one of the electrically conductive layers comprises a transparent conductive oxide.

Item 10 is the optical element of item 9, wherein the transparent conductive oxide comprises indium tin oxide.

Item 11 is the optical element of item 1 to item 10, wherein at least one of the electrically conductive layers comprises an organic electrical conductor.

Item 12 is the optical element of item 1 to item 11, wherein at least one of the electrically conductive layers comprises a blend of organic and inorganic materials.

Item 13 is the optical element of item 1 to item 12, further comprising a plurality of spacers disposed between the first and the second oriented chromonics alignment layers.

Item 14 is the optical element of item 13, wherein the plurality of spacers comprises polymeric beads.

Item 15 is a switchable privacy filter, comprising: the optical element of item 1 to item 14; and a switchable electrical source in contact with the first and second electrically conductive layers, wherein the switchable electrical source is capable of switching the LCM transmission axis between parallel and perpendicular orientations to the chromonics molecular orientation direction.

Item 16 is a switchable privacy display, comprising: the switchable privacy filter of item 15; and an information bearing display disposed adjacent the switchable privacy filter.

Item 17 is the switchable privacy display of item 16, wherein the information bearing display comprises a liquid crystal display, an electroluminescent display, an organic light emitting diode display, a cholesteric liquid crystal display, or an electrophoretic display.

Item 18 is a switchable privacy display, comprising: an information bearing display having an outer surface; a first electrically conductive layer adjacent the outer surface, and a first oriented chromonics alignment layer disposed on the first electrically conductive layer; a polymeric substrate having a second electrically conductive layer facing the first electrically conductive layer and a second oriented chromonics alignment layer disposed on the second electrically conductive surface; and a guest-host liquid crystal material (LCM) comprising a first absorbing dye, the LCM disposed between the outer surface and the polymeric substrate, and immediately adjacent the first and the second oriented chromonics alignment layers, wherein each of the first and the second oriented chromonics alignment layers include a chromonics molecular orientation direction parallel to each other.

Item 19 is the optical element of item 18, further comprising an absorbing polarizer adjacent the outer surface and having a transmission axis aligned perpendicular to the chromonics molecular orientation direction.

Item 20 is the optical element of item 18 or item 19, wherein at least one of the first and the second oriented chrominics alignment layers further comprises a second absorbing dye aligned parallel to the chromonics molecular orientation direction.

Unless otherwise indicated, all numbers expressing feature sizes, amounts, and physical properties used in the specification and claims are to be understood as being modified by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

All references and publications cited herein are expressly incorporated herein by reference in their entirety into this disclosure, except to the extent they may directly contradict this disclosure. Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

What is claimed is:

1. An optical element, comprising:
a first polymeric substrate having an outer surface, a first electrically conductive layer opposite the outer surface, and a first oriented chromonics alignment layer disposed on the first electrically conductive layer;
a second polymeric substrate having a second electrically conductive layer facing the first electrically conductive layer and a second oriented chromonics alignment layer disposed on the second electrically conductive layer; and
a guest-host liquid crystal material (LCM) comprising a first absorbing dye, the LCM disposed between the first and the second polymeric substrates and immediately adjacent the first and the second oriented chromonics alignment layers,
wherein each of the first and the second oriented chromonics alignment layers include a chromonics molecular orientation direction parallel to each other.

2. The optical element of claim 1, further comprising an absorbing polarizer adjacent the outer surface and having a transmission axis aligned perpendicular to the chromonics molecular orientation direction.

3. The optical element of claim 1, wherein at least one of the first and the second oriented chromonics alignment layers further comprises a second absorbing dye aligned parallel to the chromonics molecular orientation direction.

4. The optical element of claim 3, wherein the second absorbing dye comprises a dichroic dye aligned to the chromonics molecular orientation direction.

5. The optical element of claim 1, further comprising a barrier layer disposed between each of the first and second polymeric substrates and their respective first and second electrically conductive layers.

6. The optical element of claim 1, wherein each barrier layer comprises a plurality of sub-layers.

7. The optical element of claim 6, wherein at least one of the sub-layers comprises a polymeric material or an inorganic material.

8. The optical element of claim 7, wherein the inorganic material comprises silica.

9. The optical element of claim 1, wherein at least one of the first and second electrically conductive layers comprises a transparent conductive oxide.

10. The optical element of claim 9, wherein the transparent conductive oxide comprises indium tin oxide.

11. The optical element of claim 1, wherein at least one of the first and second electrically conductive layers comprises an organic electrical conductor.

12. The optical element of claim 1, wherein at least one of the first and second electrically conductive layers comprises a blend of organic and inorganic materials.

13. The optical element of claim 1, further comprising a plurality of spacers disposed between the first and the second oriented chromonics alignment layers.

14. The optical element of claim 13, wherein the plurality of spacers comprise polymeric beads.

15. A switchable privacy filter, comprising:
the optical element of claim 1; and
a switchable electrical source in contact with the first and second electrically conductive layers,
wherein the switchable electrical source is capable of switching the LCM transmission axis between parallel and perpendicular orientations to the chromonics molecular orientation direction.

16. A switchable privacy display, comprising:
the switchable privacy filter of claim 15; and
an information bearing display disposed adjacent the switchable privacy filter.

17. The switchable privacy display of claim 16, wherein the information bearing display comprises a liquid crystal display, an electroluminescent display, an organic light emitting diode display, a cholesteric liquid crystal display, or an electrophoretic display.

18. A switchable privacy display, comprising:
An information bearing display having an outer surface;
a first electrically conductive layer adjacent the outer surface, and a first oriented chromonics alignment layer disposed on the first electrically conductive layer;
a polymeric substrate having a second electrically conductive layer facing the first electrically conductive layer and a second oriented chromonics alignment layer disposed on the second electrically conductive layer; and
a guest-host liquid crystal material (LCM) comprising a first absorbing dye, the LCM disposed between the outer surface and the polymeric substrate, and immediately adjacent the first and the second oriented chromonics alignment layers,
wherein each of the first and the second oriented chromonics alignment layers include a chromonics molecular orientation direction parallel to each other.

19. The switchable privacy display of claim 18, further comprising an absorbing polarizer adjacent the outer surface and having a transmission axis aligned perpendicular to the chromonics molecular orientation direction.

20. The switchable privacy display of claim 18, wherein at least one of the first and the second oriented chromonics alignment layers further comprises a second absorbing dye aligned parallel to the chromonics molecular orientation direction.
